(19) United States
(12) Patent Application Publication
(10) Pub. No.: US 2018/0022083 A1
(43) Pub. Date: Jan. 25, 2018

(54) Doctor Beam

(71) Applicant: Tresu A/S, Bjert (DK)

(72) Inventor: Steffan Ellef Riemandsgaard Warming-Rasmussen, Kolding (DK)

(21) Appl. No.: 15/548,435

(22) PCT Filed: Feb. 3, 2016
(86) PCT No.: PCT/DK2016/050030

§ 371 Date: Aug. 3, 2017

(30) Foreign Application Priority Data
Feb. 4, 2015 (DK) PA 2015 70066

(51) Int. Cl. B41F 31/04; C25D 11/02; C25D 11/24

(52) U.S. Cl. CPC B41F 31/04; C25D 11/24; C25D 11/026

(57) ABSTRACT

A doctor beam for use in a printing unit, e.g. a flexographic printing unit, wherein the doctor beam has a front side with a U-shaped channel, wherein the doctor beam is made of metal and includes a surface coating produced by Plasma Electrolytic Oxidation (PEO), the surface coating at least covering the U-shaped channel, and wherein the doctor beam further includes a non-stick ceramic coating, whereby is achieved the possibility of using metal for making doctor beams without risking their degrading, neither due to chemical impact of the applied inks/lacquers/primers nor due to the destruction of the surface coating by cleaning liquids. The invention also concerns a method for treating the surface of a doctor beam and use of a doctor beam.

### FIELD OF THE INVENTION

The present invention concerns a doctor beam for use in a printing unit, e.g. a flexographic printing unit, wherein the doctor beam has a front side with a U-shaped channel.

The invention also concerns a method for treating the surface of a doctor beam and use of a doctor beam.

### BACKGROUND OF THE INVENTION

Doctor beams are well-known for use in rotary flexographic printing, a printing method particularly widespread within the packing industry. By flexographic printing, ink is transferred to paper, cardboard, plastic, metal film or similar print carrier by means of a rubber plate having a balanced amount of ink. The ink is transferred by means of an anilox roller that e.g. is a metal roller which has a multitude of tiny holes or cells, typically 10-100 μm deep, in its surface.

By varying the number of holes and the hole depths it is possible to vary the amount of ink transferred and which is typically 3-25 g/m². In order to ensure that the holes are only filled to the rim, a doctor blade is scraping across the roller. This doctor blade is most often mounted as a part of a closed ink supply system comprising a chamber. The chamber is constituted by the doctor beam having the U-shaped channel, at either side of which there is mounted a doctor blade in contact with the roller, and where the chamber at its ends is closed by end walls or packings.

The doctor beam is usually made of metal, preferably aluminium, due to the mechanical properties desired in connection with lengths of one meter or more, where it e.g. is possible to extrude aluminium.

Stainless steel is also an option, but the material is much more expensive and heavier than e.g. aluminium. Doctor beams may alternatively be made of plastic materials or composite materials. However, these doctor beams have limited application due to the mechanical properties of the materials as they are difficult to process, and as the material also can warp.

The choice of material for a doctor beam also depends on the inks, primers and types lacquer wanted to be used. Today, e.g. inks that are basic are used, thus causing a problem with corrosion of doctor beams of aluminium. In order to relieve this, coating the beams, or at least their front side that is in contact with aggressive inks, with polytetrafluoroethylene (PTFE) has been attempted.

However, this has appeared to be disadvantageous as polytetrafluoroethylene (PTFE) is only partially pH-resistant and therefore can be dissolved by certain inks, lacquers and primers. Alternatively, metal may be coated by nickel-plating or chromium-plating. This is, however, difficult if not impossible to do, especially when the doctor beam is of aluminium.

The doctor beam and the surface coating are at the same time to be resistant to cleaning liquids where e.g. ethanol also can dissolve polytetrafluoroethylene (PTFE).

For example, it is known with primers poured into water as a white/transparent granulate and dissolved therein by adding ammonium (NH₃), which is converted into ammonium ions (NH₄⁺). This raises the pH-value to about 8.2, whereby the solution becomes grainy and gel-like, and foam taking up 30-40% of the volume of the primer is produced. In order to remove the foam again, the pH-value is further raised to 8.5-9.0. This high pH value will then instead cause problems with the surface coating of e.g. polytetrafluoroethylene (PTFE) and thereby also with the doctor beam.

In particular, there are problems when the materials passing through the printing unit are provided a complete surface coating of e.g. primer as the cups in the roller thereby are emptied and contain air that e.g. is transferred to the primer, thereby forming foam.

When e.g. a primer solidifies, a necessary cleaning process will entail where cleaning liquids with higher pH values than the applied primers are used, e.g. cleaning liquids with pH values of 9 to 11, which loosen the solidified primer again, though on the other hand also destroys the surface coating of the doctor beam.

In spite of the widespread use of doctor beams, until now it has not been possible to provide doctor beams with such good mechanical properties and with a surface coating so good that it is resistant against the chemical action of the presently applied inks/lacquers/primers, and which in addition is resistant to the necessary applied cleaning liquids/cleaning agents.

An example of such a doctor beam is disclosed in WO 01/60619 A1 from where is known a doctor beam of metal for use in a printing unit, where the doctor beam has a front side with a U-shaped channel.

### OBJECT OF THE INVENTION

It is the object of the present invention to indicate a solution to these problems in a way that enables using metals for making doctor beams without risking their degrading, neither due to chemical action of the applied inks/lacquers/primers nor due to the surface coating being destroyed by cleaning liquids.

It is further an object to provide a solution which is economically profitable such that there is no economic reason for keeping the prior art solutions where mechanical scraping is needed, as opposed to the options described here where cleaning primarily of the U-shaped channel can be effected by a brush and a cleaning agent with suitable pH value.

### DESCRIPTION OF THE INVENTION

According to a first aspect of the invention, the above mentioned object is achieved by a doctor beam as described in the introduction and in the preamble of claim 1 wherein the doctor beam is made of metal and includes a surface coating produced by plasma electrolytic oxidation (PEO), where the surface coating at least covers the U-shaped channel.

By “metal” is meant the metallic elements and alloys thereof, and metal thus also includes light metals. By light metal is meant metals and alloys having substantially lower density than steel, such as e.g. aluminium, magnesium, titanium and alloys thereof.

This enables using Plasma Electrolytic Oxidation (PEO) which is an electro-chemical surface treatment producing a coating where metal is transformed into ceramics by conducting a pulsated bipolar electric current in a precisely controlled waveform through a bath of diluted aqueous electrolyte, whereby millions of microscopic lightning-like discharges of plasma are produced on the surface of the metal, gradually transforming the surface into a hard, tight layer of crystalline oxide-based ceramics that is extremely resistant to corrosion and wear.

In the PEO process, the discharge can be controlled to durations of milliseconds where currents of milliamperes are used for initiating micrometre-sized plasma reactors that mix surface material with electrolytes. This provides the option of adapting the ceramic surface layers according to wish for i.a. wearability, corrosion protection and thermal protection.

The PEO process can therefore make the surface of a doctor beam harder as well as more wear resistant than steel and glass, and it is also about twice as strong as hard anodic treatment. Besides, the surface of the doctor beam is corrosion-protected by the PEO process.

In a second aspect, the present invention also concerns that the doctor beam is made of aluminium. As aluminium is commonly used and well suited for extrusion, the limiting factor for the use of aluminium has been the soft surface and lack of wear resistance. By the PEO process, which transforms the surface into a hard and tight layer of ceramics, not only having high wear resistance but also protecting against corrosion, aluminium will also be well suited for application where wear resistance and corrosion protection are required.

An alternative to aluminium is magnesium that is also suited for extrusion, but where the limiting factor for the use of magnesium has been cost, production capacity, corrosion protection, lack of durability and wear resistance. These problems are solved by the PEO process, as mentioned above, by a hard and tight layer of ceramics, which not only has a high wear resistance but also protects against corrosion, such that these factors are no longer a limitation to the use of magnesium.

In a third aspect, the present invention also concerns a doctor beam wherein the surface coating has a thickness between 5 and 50 μm, however preferably between 10 and 20 μm, where the thickness can be adjusted according to wish and need. The outer surfaces of the doctor beam are porous after the PEO process (moon surface like) and are therefore well suited for an additional surface coating.

The surface can be polished as an alternative to the additional surface coating.

In a fourth aspect, the present invention also concerns a doctor beam wherein the said surface coating covers the entire doctor beam, which probably most often will be the case, as the fastest, easiest and cheapest way will be to submerge the doctor beam in a bath with the aqueous electrolyte.

In a fifth aspect, the present invention also concerns a doctor beam wherein the doctor beam further includes a non-stick ceramic coating which at least covers the U-shaped channel.

By a ceramic surface coating, substantial improvements of tribological issues, such as wear, friction, corrosion, slippage and maintenance, can be achieved. A ceramic surface coating can e.g. be achieved by means of processes like e.g. PVD, PACVD, CVD and ion implantation.

Polishing the doctor beam after the PEO process can thereby be avoided as the surface coating attaches well on the porous surface structure. In addition, the surface coating is provided good wearability due to great hardness, good corrosion properties, as the surface coating basically is a ductile glass that can stand impacts without breaking. Moreover, the surface treatment can contain a colour such that it can withstand cleaning liquids such as e.g. ethanol without being dissolved.

In a sixth aspect, the present invention also concerns a doctor beam wherein the ceramic coating has a thickness between 30 and 50 μm, however preferably between 20 and 30 μm, where the thickness can be adjusted according to wish and need. After the surface coating, the outer surfaces of the doctor beam are hard, tough and very wear resistant.

In a seventh aspect, the present invention also concerns a doctor beam wherein the ceramic coating covers the entire surface of the doctor beam, which probably will be case by this surface coating as it is quicker, easier and cheaper to spray and apply the surface coat on the entire surface of the doctor beam and thereby avoid time-consuming coverings.

In an eighth aspect, the present invention also concerns a method for treating the surface of a doctor beam, the method at least including the following steps:

A: the doctor beam is laid into an aqueous electrolyte; and
B: a pulsating bipolar electric current in a precisely controlled waveform is conducted through the electrolyte.

This will enable coating at least parts of the doctor beam and preferably the entire doctor beam as the aqueous electrolyte enters all corners and nooks of the doctor beam.

In an ninth aspect, the present invention also concerns a method for treating the surface of a doctor beam, wherein the method at least further includes the following steps:

C: a coating is applied the surface of the doctor beam; and
D: the coating is cured at 250° C.

This will enable application of the surface coating preferably by spraying it on at least parts of the surface of the doctor beam or the entire surface of the doctor beam, after which the doctor beam is put into an oven at 250° C. where the coating is cured.

In a tenth aspect, the present invention also concerns a doctor beam for use in a printing unit, e.g. a flexographic printing unit.

### DESCRIPTION OF THE DRAWING

The invention will now be explained more closely in the following by description of non-limiting embodiments with reference to the drawing, where:

FIG. 1 shows a schematic section through a doctor beam;

### LIST OF DESIGNATIONS

1 Doctor beam
2 front side
3 U-shaped channel
4 chamber
5 doctor blade
6 printing roller
7 plasma electrolytic oxidation
8 surface coating

### DETAILED DESCRIPTION OF THE INVENTION

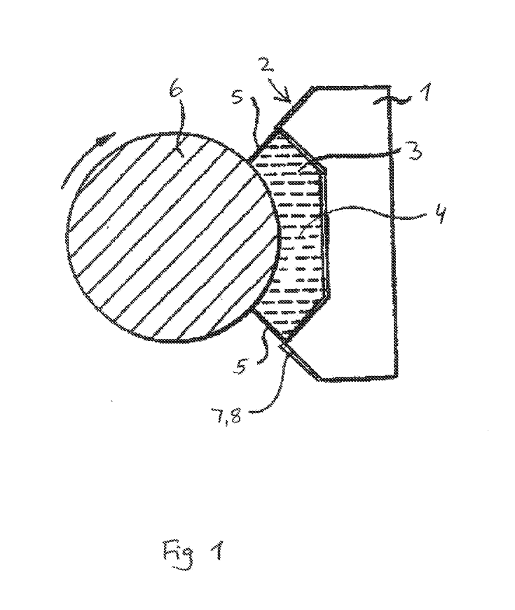

It appears on FIG. 1 that the doctor beam 1 has a front side 2 in which is formed a U-shaped channel 3. This U-shaped channel 3 forms a part of a chamber 4 which is further delimited by doctor blades 5 disposed at either side of the U-shaped channel 3, and by a printing roller 6. The delimited chamber 4 is used for the applied primer, ink or lacquer.

The doctor beam 1 has a surface that has gone through a plasma electrolytic oxidation 7 at least covering the U-shaped channel 3, but which in the shown embodiment extends along the whole front side 2 of the doctor beam.

The doctor beam 1 can have a surface additionally provided with a surface coating 8 which at least covers the U-shaped channel 3, but which in the shown embodiment also extends over the whole front side 2 of the doctor beam.

1. A doctor beam for use in a printing unit, e.g. a flexographic printing unit, wherein the doctor beam has a front side with a U-shaped channel, wherein the doctor beam is made of metal and includes a surface coating produced by plasma electrolytic oxidation (PEO), where the surface coating at least covers the U-shaped channel, and where the doctor beam further includes a non-stick ceramic coating at least covering the U-shaped channel.

2. A doctor beam according to claim 1, wherein the doctor beam is made of aluminium.

3. A doctor beam according to claim 1, wherein the surface coating produced by plasma electrolytic oxidation (PEO) has a thickness between 5 and 50 μm.

4. A doctor beam according to claim 1, wherein the surface coating produced by plasma electrolytic oxidation (PEO) covers the entire doctor beam.

5. A doctor beam according to claim 1, wherein the ceramic coating has a thickness between 30 and 50 μm.

6. A doctor beam according to claim 1, wherein the ceramic coating covers the entire surface of the doctor beam.

7. A method for surface treatment of a doctor beam according to claim 1 for use in a printing unit, e.g. a flexographic printing unit, wherein the method includes at least the following steps:
A: the doctor beam is laid into an aqueous electrolyte; and
B: a pulsating bipolar electric current is conducted through the electrolyte.

8. A method for surface treatment of a doctor blade according to claim 7, wherein the method further includes at least the following steps:
C: a coating is applied the surface of the doctor beam; and
D: the coating is cured at 250° C.

9. Use of a doctor beam according to claim 1 for use in a printing unit, e.g. a flexographic printing unit.
